(19) United States
(12) Patent Application Publication
(10) Pub. No.: US 2021/0011329 A1
(43) Pub. Date: Jan. 14, 2021

(54) LIQUID-CRYSTAL DEVICE

(71) Applicant: InnoLux Corporation, Miao-Li County (TW)

(72) Inventors: Chin-Yi KUO, Miao-Li County (TW); Ying-Chieh TSAI, Miao-Li County (TW); Cheng-Jen CHU, Miao-Li County (TW)

(21) Appl. No.: 16/918,201

(22) Filed: Jul. 1, 2020

Related U.S. Application Data
(60) Provisional application No. 62/874,121, filed on Jul. 15, 2019.
(60) Provisional application No. 62/871,362, filed on Jul. 8, 2019.

(30) Foreign Application Priority Data
Apr. 9, 2020 (CN) 202010272220.5

(51) Int. Cl. G02F 1/1333; H05B 3/00

(52) U.S. Cl. CPC G02F 1/133382; H05B 3/0014; H05B 2203/007; H05B 2203/014; G02F 2201/56

(57) ABSTRACT

A liquid crystal device includes a pair of substrates, a liquid crystal, and a plurality of heating units. The liquid crystal is disposed between the pair of substrates. The plurality of heating units are disposed on one of the pair of substrates, wherein the heating units are separated from each other. Each of the heating units includes a first voltage line, a second voltage line, and a plurality of heating lines coupled between the first voltage line and the second voltage line.

### CROSS REFERENCE TO RELATED APPLICATIONS

This application claims the benefit of U.S. Provisional Application No. 62/871,362, filed on Jul. 8, 2019, and U.S. Provisional Application No. 62/874,121, filed on Jul. 15, 2019, the entirety of which are incorporated by reference herein.

This application claims priority of China Patent Application No. 202010272220.5, filed on Apr. 9, 2020, the entirety of which is incorporated by reference herein.

### BACKGROUND OF THE INVENTION

### Field of the Invention

The present disclosure relates to a liquid-crystal device, and in particular, to a liquid-crystal device with a heating unit.

### Description of the Related Art

Liquid-crystal devices utilize the variances of illuminance by controlling the arrangement of the liquid-crystal modules or adjusting the fed-in electromagnetic waves. Since the response time of liquid-crystal modules is affected by temperature, this will affect the operation of liquid-crystal devices. Therefore, an improved liquid crystal is required.

### BRIEF SUMMARY

The present disclosure provides a liquid-crystal device. The liquid-crystal device includes a pair of substrates, a liquid crystal, and a plurality of heating units. The liquid crystal is disposed between the pair of substrates. The plurality of heating units are disposed on one of the pair of substrates. The plurality of heating units are separated one another. The plurality of heating units each includes a first voltage line, a second voltage line, and a plurality of heating lines coupled between a first voltage line and a second voltage line.

### BRIEF DESCRIPTION OF THE DRAWINGS

In order to describe the manner in which the above-recited features and other advantages of the disclosure can be obtained, a more particular description of the principles briefly described above will be rendered by reference to specific examples thereof which are illustrated in the appended drawings. It should be understood that these drawings depict only exemplary aspects of the disclosure and are therefore not to be considered to be limiting of its scope. The principles herein are described and explained with additional specificity and detail through the use of the accompanying drawings, in which:

FIG. 1 is a cross-sectional view of a liquid-crystal device in accordance with some embodiments of the present disclosure.

FIG. 2A is a top view of a liquid-crystal device with a rectangular substrate in accordance with some embodiments of the present disclosure.

FIG. 2B is a top view of a liquid-crystal device with a rectangular substrate in accordance with some embodiments of the present disclosure, in which the heating unit has a plurality of heating lines.

FIG. 3A is a top view of a liquid-crystal device with an irregularly-shaped substrate in accordance with some embodiments of the present disclosure, in which the heating unit has a plurality of heating lines with different widths.

FIG. 3B is a top view of a liquid-crystal device with an irregularly-shaped substrate in accordance with some embodiments of the present disclosure, in which the heating unit has a plurality of heating lines of identical width.

FIG. 4A is a top view of a liquid-crystal device with a rectangular substrate in accordance with some embodiments of the present disclosure, in which the liquid-crystal device has a plurality of heating units, each of which has a sheet-shaped heating line.

FIG. 4B is a top view of a liquid-crystal device with a rectangular substrate in accordance with some embodiments of the present disclosure, in which the liquid-crystal device has a plurality of heating units, each of which has a plurality of heating lines.

FIG. 5A is a top view of a liquid-crystal device with irregularly-shaped substrate in accordance with some embodiments of the present disclosure, in which the liquid-crystal device has a plurality of heating units, each of which has a plurality of heating lines of different widths.

FIG. 5B is a top view of a liquid-crystal device with irregularly-shaped substrate in accordance with some embodiments of the present disclosure, in which the liquid-crystal device has a plurality of heating units, each of which has a plurality of heating lines of identical width.

FIG. 6 is a top view of a liquid-crystal device having a heating unit in accordance with some embodiments of the present disclosure, in which the heating unit has the heating lines separated by an identical distance.

### DETAILED DESCRIPTION

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

For purposes of the present detailed description, unless specifically disclaimed, the singular includes the plural and vice versa; and the word “including” means “including without limitation.” Moreover, words of approximation, such as “about,” “almost,” “fairly,” “approximately,” “substantially,” and the like, can be used herein to mean “at, near, or nearly at,” or “usually within a given range such as 10%, 5%, 3%, 2%, 1%, or 0.5% of,” or “within acceptable manufacturing tolerances,” or any logical combination thereof, for example.

Furthermore, spatially relative terms, such as “beneath,” “below,” “lower,” “above,” “upper” and the like, may be used herein for ease of description to describe one element or feature's relationship to another element or feature as illustrated in the figures. The spatially relative terms are intended to encompass different orientations of the device in use or operation in addition to the orientation depicted in the figures. For example, if the device in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

The terminology used herein is for the purpose of describing particular embodiments only, and is not intended to be limiting of the present disclosure. As used herein, the singular forms “a”, “an” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore terms, such as those defined in commonly used dictionaries, should be interpreted as having a meaning that is consistent with their meaning in the context of the relevant art, and will not be interpreted in an idealized or overly formal sense unless expressly so defined herein.

Liquid crystal devices (such as liquid crystal displays or electromagnetic wave adjustment devices containing liquid crystals) have liquid crystals, which are affected by external temperature. When the external temperature is low, the response time of the liquid crystal device becomes long, resulting in poor performance. Conversely, when the external temperature is high, the response time of the liquid crystal device will become shorter, making the pixels change faster, and the liquid crystal device has better performance.

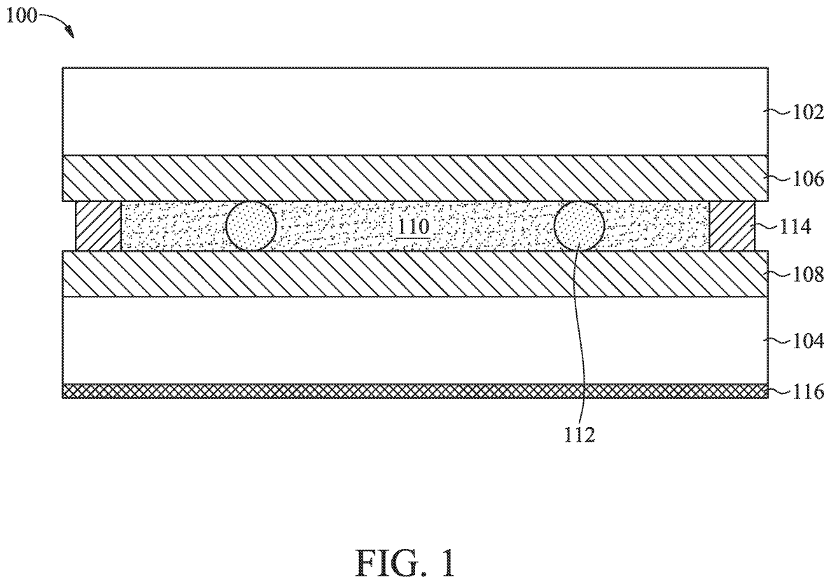

FIG. 1 is a cross-sectional view of a liquid-crystal device in accordance with some embodiments of the present disclosure. The liquid-crystal device 100 includes an upper substrate 102, a lower substrate 104, a multi-layer material structure 106, a multi-layer material structure 108, a liquid crystal 110, a spacer 112, a sealant 114, and a heating layer 116.

The upper substrate 102 and the lower substrate 104 are arranged oppositely. The upper substrate 102 and the lower substrate 104 may be a rigid substrate or a flexible substrate, and the material includes, but not limited to, organic materials or inorganic materials.

The multi-layer material structure 106 and the multi-layer material structure 108 are disposed on the upper substrate 102 and the lower substrate 104 respectively. More specifically, the multi-layer material structure 106 is disposed on the lower surface of the upper substrate 102 (below), and the multi-layer material structure 108 is disposed on the upper surface of the lower substrate 104 (above). The multi-layer material structure 106 and the multi-layer material structure 108 each includes a plurality of material layers, such as at least one isolating layer, at least one of conducting layer, or at least one of semiconductor layer. The isolating layer may be an inorganic layer or an organic layer. In some embodiments, the multi-layer material structure 106 or the multi-layer material structure 108 may have a plurality of conducting layers, a semiconductor layer, and a plurality of isolating layers so as to form metal routings, circuit structures or switch devices (for example, TFT), but not limited thereto.

Liquid crystal 110 is disposed between the upper substrate 102 and the lower substrate 104, below the multi-layer material structure 106, and above the multi-layer material structure 108. In other embodiments, the liquid crystal 110 may be between the multi-layer material structure 106 and the multi-layer material structure 108. The liquid crystal 110 has liquid-crystal molecules (not shown).

The spacer 112 is disposed between the multi-layer material structure 106 and the multi-layer material structure 108, and within the liquid crystal 110. The spacer 112 may support the upper substrate 102 (or the multi-layer material structure 106) and the lower substrate 104 (or the multi-layer material structure 108) to provide a consistent spacing. The spacer 112 may include a substantially spherical object, or the spacer 112 may be disposed on the multi-layer material structure 106 or on the multi-layer material structure 1068 through a photolithography process, but it is not limited thereto.

The sealant 114 is disposed between the multi-layer material structure 106 and the multi-layer material structure 108 and surrounding the liquid crystal 110. The sealant 114 may be configured to prevent the liquid crystal 110 from leaking. The sealant 114 may include light-sensitive polymer or light-sensitive resin, such as hydroxy epoxy resin and bisphenol epoxy resin, but it is not limited thereto.

The heating layer 116 is configured to heat the liquid-crystal device 100. The heating layer 116 may include a conductive material, such as copper (Cu), aluminum (Al), molybdenum (Mo), titanium (Ti), and indium tin oxide (ITO), but it is not limited thereto. Since the heating layer 116 has a resistance value, the heating 116 generates heat to heat the liquid-crystal device 100 when a voltage is applied to the heating layer 116.

As shown in FIG. 1, the heating layer 116 may be disposed on the lower substrate 104. More specifically, in FIG. 1, the heating layer 116 is disposed on the lower surface of the lower substrate 104. In some embodiments, the heating layer 116 may be disposed on the upper substrate 102. More specifically, the heating layer 116 may be disposed on the upper surface of the upper substrate 102.

Regarding the heating efficiency of the heating layer 116, the heating layer 116 may be disposed near the liquid crystal 110. For example, in some embodiments, the heating layer 116 may be disposed on the upper surface of the lower substrate 104, which indicates that the heating layer 116 s disposed between the multi-layer material structure 108 and the lower substrate 104. In other embodiments, the heating layer 116 may be disposed on the lower surface of the upper substrate 102, which indicates that the heating layer 116 is disposed between the upper substrate 102 and the multi-layer material structure 106. In order to improve the heating efficiency of the heating layer 116, in some embodiments, the heating layer 116 may be disposed above the lower substrate 104 and within the multi-layer material structure 108 (which can be viewed as part of the multi-layer material structure 108). In other embodiments, the heating layer 116 may be disposed below the upper substrate 102 and within the multi-layer material structure 106 (can be viewed as part of the multi-layer material structure 106). In some embodiments, one of the conductive layers in the multi-layer material structure 108 may be designed as the heating layer 116, but it is not limited thereto. In some embodiments, one of the conductive layers in the multi-layer material structure 106 may be designed as the heating layer 116, but not limited thereto.

In some embodiments, the liquid-crystal device 100 may include at least two heating layer. One of the heating layers may be disposed on the lower substrate 104 (including the upper surface and the lower surface of the lower substrate 104), or one the lower substrate 104 and within the multi-layer material structure 108. The other of the heating layers may be disposed on the upper substrate 102 (including the upper surface or the lower surface of the upper substrate 102), or below the upper substrate 102 and within the multi-layer material structure 106. It is not intended to be limited thereto.

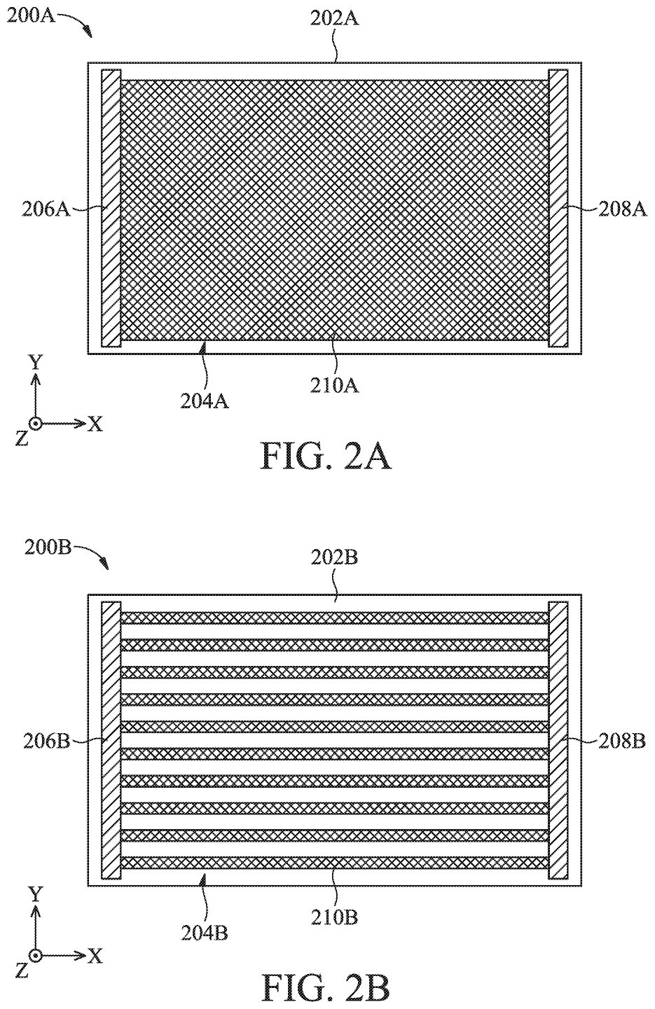

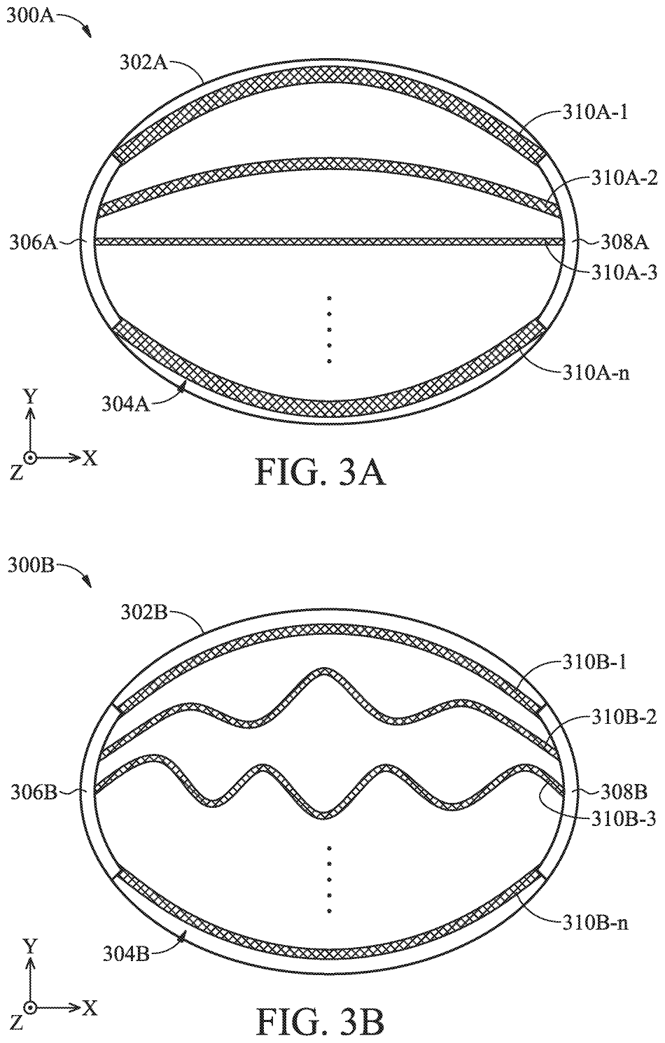

The heating layer 116 may include one or more heating unit. FIG. 2A to FIG. 3B illustrate an embodiment of the heating layer including a heating unit. FIG. 2A and FIG. 2B are top view of a rectangular-shaped liquid-crystal device. FIG. 3A and FIG. 3B are top view of an irregularly-shaped liquid-crystal device, and oval is illustrated herein. For simplicity, the liquid-crystal devices of FIG. 2A to FIG. 3B only show the substrate and the heating unit, and the remaining elements will not be repeatedly displayed and described.

FIG. 2A illustrates a liquid-crystal device 200A. The liquid-crystal device 200A includes a substrate 202A and a heating unit 204A. The heating unit 204A includes a first voltage line 206A, a second voltage line 208A, and a heating line 210A. The first voltage line 206A and the second voltage line 208A are respectively disposed on two different edges along the substrate 202A, but they are not limited thereto. In one embodiment, the first voltage line 206A and the second voltage line 208A may be disposed on the same edge along the substrate 202A, but they are not limited thereto. The heating line 210A is coupled between the first voltage line 206A and the second voltage line 208A. In one embodiment, the heating line 210A is sheet-shaped (which can be called a sheet-shaped heating line), and substantially overlapped with the substrate 202A. Therefore, in the embodiment, when a voltage is applied to the first voltage line 206A and the second voltage line 208A, a single heating line 210A is able to heat the whole liquid-crystal device 200A. It should be understand that the sheet-shaped heating line can be also applied to an irregularly-shaped liquid-crystal device. In one embodiment, the first voltage line may be the voltage input line and the second voltage line may be the voltage output line, but they are not limited thereto.

In some embodiments, a single heating unit may include a plurality of heating lines. As shown in FIG. 2B, the liquid-crystal device 200B includes a substrate 202B and a heating unit 204B. The heating unit 204B includes a first voltage line 206B, a second voltage line 208B, and a plurality of heating lines 210B. Similarly, the first voltage line 206B and the second voltage line 208B may be respectively disposed along the edge of the substrate 202B, but they are not limited thereto. The plurality of heating lines 210B are coupled between the first voltage line 206B and the second voltage line 208B. In the embodiment, a plurality of heating lines 210B may be distributed with identical spacing (for example, in the Y-direction) to heat the whole liquid-crystal device 200B, but it is not limited thereto.

As stated above, the liquid-crystal devices in FIG. 3A and FIG. 3B have an irregularly-shaped substrate, which is illustrated herein as an oval but they are not limited thereto. In FIG. 3A, the liquid-crystal device 300A includes a substrate 302A and a heating unit 304A. The heating unit 304A includes a first voltage line 306A, a second voltage line 308A, and heating lines 310A-1, 310A-2, 310A-3, . . . , 310A-n (collectively referred to as the heating line 310A). In FIG. 3B, the liquid-crystal device 300B includes a substrate 302B and a heating unit 304B. The heating unit 304B includes a first voltage line 306B, a second voltage line 308B, and heating lines 310B-1, 310B-2, 310B-3, . . . , 310B-n (collectively referred to as the heating line 310B). The arrangement and connection of each component in FIG. 3A and FIG. 3B are identical to those in FIG. 2A and FIG. 2B, which will not be repeated herein.

In the embodiment in FIG. 2A to FIG. 3B, the thermal power of each heating line can follow the following equation:

$$P = \frac{{V}^{2}}{R} \qquad ( 1 )$$

In the equation above, P is power (the unit is watt (W)), V is the driving voltage of the heating unit (i.e., the voltage difference of the first voltage line and the second voltage line and the unit is volt (V)), and R is the resistance value of the heating line (the unit is ohm (Ω)). In the individual embodiments of FIG. 2A to FIG. 3B, since each heating line is identically coupled between the first voltage line and the second voltage line, the voltage difference across each heating line is substantially identical. In order to make each heating line heat with substantially identical power, the resistance value of each heating line is designed to be substantially identical.

The resistance value of each heating line can follow the following equation:

$$R = ρ \times \frac{L}{W \times d} \qquad ( 2 )$$

In the equation above, R is the resistance value of the heating lines, p is the resistivity of the material of the heating lines (the unit is ohm-meter (Ω·m)), L is the length of the heating lines (for example: along the direction perpendicular to the extending direction of the heating lines and the unit is meter (m)), and d is the thickness of the heating line (for example: in the Z-direction and the unit is meter (m)). As illustrated in FIG. 2B, L is the length in the X-direction, W is the length in the Y-direction, and d is the length in the Z-direction. Since each heating line is simultaneously formed in the same process and of the same material (for example: the conductive material as stated above), the thickness (d) and the resistivity (p) of each heating line would be substantially identical. Therefore, different heating lines may have substantially an identical resistance value by adjusting or designing the lengths (L) or the widths (W) of the heating lines. More specifically, since the thickness (d) and the resistivity (p) of the heating lines are substantially identical, the resistance value of each heating line can be substantially identical when the ratios of the length (L) over the width (W) of different heating lines are designed to be substantially identical.

For the heating lines to heat the liquid-crystal device with a better efficiency, the heating lines can cover the substrate (or overlap with the substrate). For example, in the embodiment of FIG. 3A, the heating lines 310 each has different length. More specifically, in the embodiment of FIG. 3A, the heating lines disposed along the edges of the substrate 302A (such as the heating line 310A-1) is the longest among the heating lines 310A, and the heating lines disposed around the center of the substrate 302A (such as the heating line 310A-3) is the shortest among the heating lines 310A. As stated above, in order to make the resistance values of the heating lines substantially identical, the lengths (L) or the widths (W) of the heating lines can be adjusted or designed. Therefore, in the embodiment of FIG. 3A, the widths of the longest the heating lines 310A (such as heating line 310A-1 and heating line 310A-n) are designed to be the largest, and the widths of the shortest heating lines 310A (such as heating line 310A-3) can be designed to be the smallest.

In the embodiment of FIG. 3B, the width of each of the heating lines 310B is substantially identical. Therefore, in order to make the resistance value of each of the heating lines 310B identical, the lengths of the heating lines 310B should be adjusted or designed. Therefore, some of the heating lines 310B are curvedly disposed on the substrate 302B (such as the heating line 310B-2 and the heating line 310B-3) such that the length of each of the heating lines 310B is substantially identical so as to make the resistance value of each of the heating lines 310B substantially identical.

The design of the heating unit (heating layer) is related to the following equation:

$$\frac{Δ T}{Δ t} = \frac{P}{A} \times \frac{1}{C \times d} \qquad ( 3 )$$

In the equation above, ΔT is the temperature difference (the unit is □), Δt is the time difference (the unit is second), P is the power, A is the cross-sectional area of the heating line in top view, C is the specific heat capacity of the material of the heating line, and d is the thickness of the heating line.

According to equation (3), it indicates that ΔT is proportional to P (ΔT∝P). According to equation (1), it indicates that P is proportional to

$$\frac{1}{R} ( P ∝ \frac{1}{R} ) .$$

In the embodiments of the present disclosure, the liquid-crystal device can be heated to a target temperature in the application of liquid-crystal device with heating design. In one embodiment, the target temperature for heating may be room temperature, such as 25□, but it is not limited thereto. In the embodiment, when the target temperature has a ±10□ temperature variation window, the design variation of the resistance values of the heating lines may be about ±16%.

As stated above, in some embodiments, the thicknesses of the heating lines are substantially identical and the widths or the lengths of the heating lines can be adjusted to make the resistance values of the heating lines substantially identical. However, in some circumstances, since there may be some process variation during the formation of the heating unit (heating layer), the thickness of the heating lines in different regions may be inconsistent. Therefore, a plurality of heating units can be disposed in the liquid-crystal device and the voltage difference of the heating units (i.e., the voltage difference between the first voltage line and the second voltage line) can be individually adjusted so that each of the heating units can heat the liquid-crystal device with substantially identical thermal power.

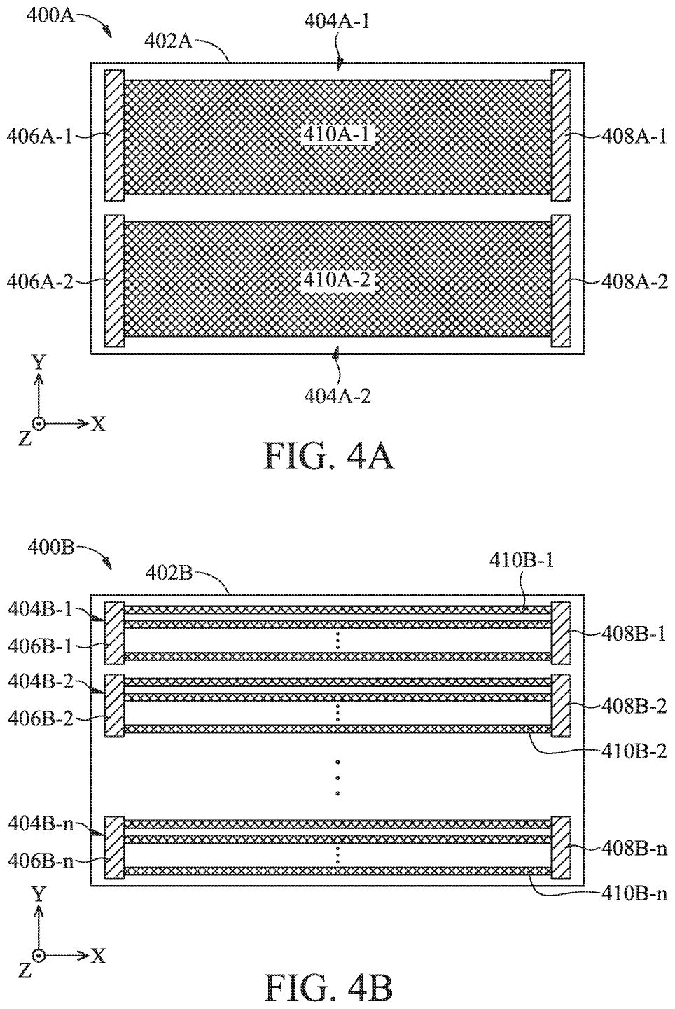

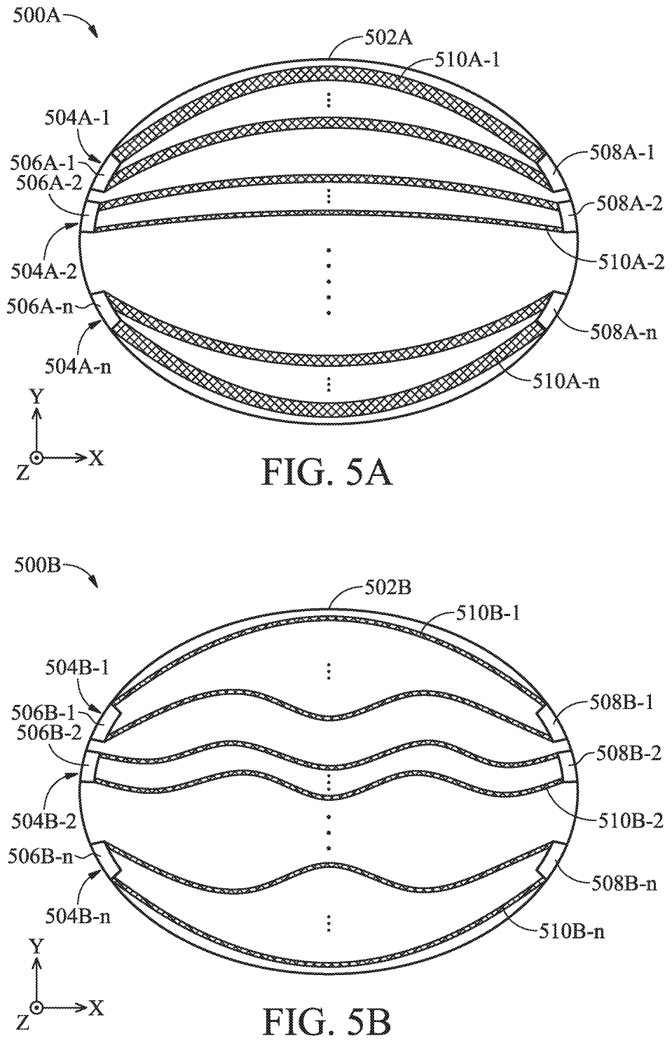

FIG. 4A to FIG. 5B illustrate the embodiments of the heating layer including a plurality of heating units. FIG. 4A and FIG. 4B are top view of a rectangular-shaped liquid-crystal device. FIG. 5A and FIG. 5B are top view of an irregularly-shaped liquid-crystal device. For the simplicity, the liquid-crystal device in FIG. 4A to FIG. 5B merely illustrates the substrate and the heating units, and the other elements will not be repeated and described.

FIG. 4A shows a liquid crystal device 400A. The liquid crystal device 400A in FIG. 4A is similar to the liquid crystal device 200A in FIG. 2A, but the liquid crystal device 400A includes 2 heating units. It is not intended to be limited thereto. For example, the liquid crystal device 400A includes a substrate 402A and heating units 404A-1 and 404A-2. The heating unit 404A-1 includes a first voltage line 406A-1, a second voltage line 408A-1, and a heating line 410A-1. The heating unit 404A-2 includes a first voltage line 406A-2, a second voltage line 408A-2, and a heating line 410A-2. The heating lines 410A-1 and 410A-2 may be sheet-shaped (can be called as a sheet-shaped heating line), but they are not limited thereto. In the embodiment, two heating lines 410A-1 and 410A-2 are utilized to heat the whole liquid crystal device 400A. The heating units 404A-1 and 404A-2 can be applied with different voltage differences respectively (i.e., the voltage difference between the first voltage line 406A-1 and the second voltage line 408A-1 of the heating unit 404A-1 is different from that between the first voltage line 406A-2 and the second voltage line 408A-2 of the heating unit 404A-2) to heat the liquid crystal device 400A. More specifically, as stated above, there may be some process variation during the formation of the heating units (the heating layer) so that the thicknesses of the heating lines in different regions may be inconsistent. According to equation 2, when the thickness (d) of the heating line is larger, the resistance value of the heating line (R) is smaller. Therefore, according to equation (1), the driving voltage (V) of the heating unit (i.e., the voltage difference between the first voltage line and the second voltage line) can be reduced to adjust the influence caused by the heating lines with inconsistent thicknesses. For example, in FIG. 4A, when the thickness of the heating line 410A-2 of the heating unit 404A-2 exceeds that of the heating line 410A-1 due to process variation, it leads that the resistance value of the heating line 410A-2 is a quarter of that of the heating line 410A-1 of the heating unit 404A-1 (or the resistance value of the heating line 410A-1 is 4-fold of that of the heating line 410A-2). Under this circumstance, the driving voltage difference of the heating unit 404A-2 can be adjusted to be a half of that of the heating unit 404A-1 (or the driving voltage difference of the heating unit 404A-1 can be adjusted to be 2-fold of that of the heating unit 404A-2) so that the heating units 404A-1 and 404A-2 can heat the liquid crystal device 400A with substantially identical power.

In FIG. 4B, the liquid crystal device 400B is similar to the liquid crystal device 200B in FIG. 2B, but the liquid crystal device 400B includes the substrate 402B and a plurality of heating units 404B-1, 404B-2, . . . , 404B-n. Each of the heating units 404B-1-404B-n includes a first voltage line (first voltage lines 406B-1, 406B-2, . . . , 406B-n), a second voltage line (second voltage lines 408B-1, 408B-2, . . . , 408B-n), a plurality of heating lines (heating lines 410B-1, 410B-2, . . . , 410B-n). Similarly, the heating units 404B-1-404B-n can be individually applied with different voltage differences (i.e., the voltage differences between the first voltage line and the second voltage line of the heating units 404B-1-404B-n are different) to heat the liquid crystal device 400B.

In FIG. 5A, the liquid crystal device 500A, which is similar to the liquid crystal device 300A in FIG. 3A, is an irregularly-shaped liquid crystal device. The liquid crystal device 500A includes a substrate 502A and a plurality of heating units 504A-1, 504A-2, . . . , 504A-n. Each of the heating units 504A-1-504A-n includes a first voltage line (first voltage lines 506A-1, 506A-2, . . . , 506A-n), a second voltage line (second voltage lines 508A-1, 508A-2, . . . , 508A-n), a plurality of heating lines (a plurality of heating lines 510A-1, a plurality of heating lines 510A-2, . . . , a plurality of heating lines 510A-n). In the embodiment, the lengths of the heating lines 510A are different from one another. The width of the longest one of the heating lines 510 (the heating lines being closest to the edges of the substrate 502A, such as the heating lines 510A-1 and 510A-n) is designed to be the largest, and the width of the shortest one of the heating lines 510A is designed to be the smallest. If the thicknesses of the heating lines 510A are substantially identical, the resistance values of the heating lines 510A are also substantially identical. However, when there is some process variation during the formation of the heating units 504A, it may lead to the thicknesses of the heating lines 510A in different regions of the liquid crystal device 500A being different. Therefore, as stated above, the heating units 504A-1 to 504A-n may be applied with different voltage differences respectively (i.e., the voltage difference between the first voltage line and the second voltage line of each of the heating units 504A-1 to 504A-n is different) to heat the liquid crystal device 500A.

In FIG. 5B, the liquid crystal device 500B, which is similar to the liquid crystal device 300B in FIG. 3B, is an irregularly-shaped liquid crystal device. The liquid crystal device 500B includes a substrate 502B and a plurality of heating units 504B-1, 504B-2, . . . , 504B-n. Each of the heating units 504B-1 to 504B-n includes a first voltage line (first voltage lines 506B-1, 506B-2, . . . , 506B-n), a second voltage line (second voltage lines 508B-1, 508B-2, . . . , 508B-n), a plurality of heating lines (a plurality of heating lines 510B-1, a plurality of heating lines 510B-2, . . . , a plurality of heating lines 510B-n). in the embodiment, the widths of the heating lines 510B are substantially identical and some of the heating lines 510B are curvedly disposed on the substrate 502B, so that the length of each of the heating lines 510B is substantially identical. When the thicknesses of the heating lines 510B are substantially identical, the resistance values of the heating lines 510 are also substantially identical. However, when there is some process variation during the formation of the heating units 504B, it may lead to the thickness of the heating lines 510B in different regions of the liquid crystal device 500B being different. Therefore, as stated above, the heating lines 504B-1 to 504B-n each can be applied with different voltage difference (i.e., the voltage differences between the first voltage line and the second voltage line of the heating lines 504B-1 to 504B-n are different) to heat the liquid crystal device 500B.

In some embodiment, every two adjacent heating units can form a group, and each group of heating units has an individual voltage difference (i.e., the voltage difference between the first voltage line and the second voltage line). However, in each group of heating units, the absolute value of the voltage difference of each two adjacent heating units may be identical. In the embodiment, a sum of the voltage differences of the voltages respectively applied to the first voltage lines of two adjacent heating units related to a reference voltage is 0, and a sum of the voltage differences of the voltages respectively applied to the second voltage lines of two adjacent heating units related to a reference voltage is also 0. For example, in FIG. 4B, the adjacent heating unit 404B-1 and heating unit 404B-2 form a group. The first voltage line 406B-1 of the heating unit 404B-1 may be applied with 7V, and the first voltage line 406B-2 of the heating unit 404B-2 may be applied with 5V. The second voltage line 408B-1 of the heating unit 404B-1 may be applied with 3V, and the second voltage line 408B-2 of the heating unit 404B-2 may be applied with 9V. 7V applied to the first voltage line 406B-1 related to 6V is increased by 1V (+1V). 5V applied to the first voltage line 406B-2 related to 6V is decreased by 1V (−1V). Therefore, 6V is a reference voltage, and the sum of the voltage differences of 7V and 5V related to the reference voltage (6V) is 0. Similarly, the voltage difference of 3V applied to the second voltage line 308B-1 related to 6V is −3V, and the voltage difference of 9V applied to the first voltage line 406B-2 related to 6V is +3V. Therefore, the sum of the voltage differences of 3V and 9V related to the reference voltage (6V) is 0. In this way, it may mitigate the influence of the heating unit 404B-1 and the heating unit 404B-2 to other signals in the liquid crystal device 400B.

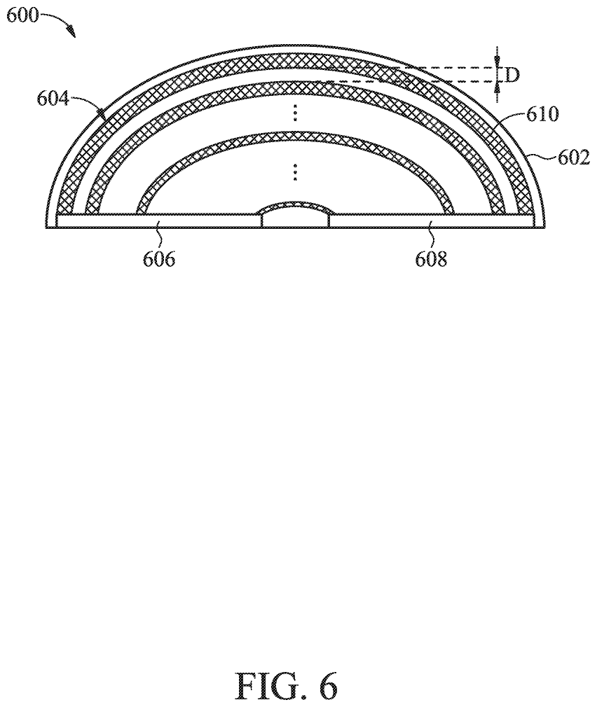

In above embodiment, the heating unit is designed to heat the liquid crystal device with substantially identical power. In some embodiments, it is considered to heat the liquid crystal device with better efficiency so that the power density generated by the heating units is substantially identical. FIG. 6 is a top view of a liquid crystal device in accordance with some embodiments in the present disclosure, in which the heating unit includes a plurality of heating lines separated by substantially identical spacing D. the liquid crystal device 600 includes a substrate 602 and heating unit 604. In the embodiment, the substrate 602 may be a semicircular substrate, but it is not limited thereto. The heating unit 604 includes a first voltage line 606, a second voltage line 608, and a plurality of heating lines 610. The first voltage line 606 and the second voltage line 608 are disposed on the straight edge of the substrate 602, but they are not limited thereto. Each of the heating lines 610 is coupled between the first voltage line 606 and the second voltage line 608 and they are separated from one another by substantially identical spacing D. The heating line 610 disposed closest to the arc edge of the substrate 602 is the longest, and the heating line 610 disposed farthest away from the arc edge of the substrate 602 is the shortest.

As stated above, the thermal power of each heating line can follow equation (1), and the resistance value of each heating line can follow equation (2). Therefore, in the embodiment, the power density of each of the heating lines 610 can follow the following equation:

$$PD = \frac{P}{L} = \frac{{V}^{2}}{R \times L} = \frac{W \times d}{ρ \times {L}^{2}} \times {V}^{2} \qquad ( 4 )$$

Since the heating lines 610 may be simultaneously formed in the same process and include the identical material (for example, the conductive materials as stated above), thickness or the resistivity of the heating lines 610 is substantially identical. In addition, the heating lines 610 each is coupled between the same first voltage line 606 and second voltage line 608, and the voltage difference across each of the heating lines 610 is substantially identical. Under these circumstances, according to the equation above, it would be understood that a ratio of the width over the square of length

$$( \frac{W}{{L}^{2}} )$$

or each heating lines 610 is substantially constant (i.e.

$$\frac{W}{{L}^{2}}$$

value of each of the heating lines 610 is substantially identical), or that the resistance value by the length (R×L) is substantially constant (i.e., the value of R×L of each of the heating lines 610 is substantially identical), such that the thermal power of each of the heating lines 610 is substantially identical. In the embodiment, according to the conditions above, the width of one of the heating lines 610 closest to the arc edge of the substrate 602 may exceed that of one of the heating lines 610 farthest away from the arc edge of the substrate 602. The features of the embodiments introduced herein may be mixed without departing from the scope and spirit of this present disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A liquid crystal device, comprising:
a pair of substrates;
a liquid crystal, disposed between the pair of substrates; and
a plurality of heating units, disposed on one of the pair of substrates, wherein the plurality of heating units are separated from one another;
wherein each of the plurality of heating units includes a first voltage line, a second voltage line, and a plurality of heating lines, and the heating lines are coupled between the first voltage line and the second voltage line.

2. The liquid crystal device of claim 1, further comprising:
a multi-layer material structure, disposed on one of the pair of substrates, wherein the plurality of heating units are within the multi-layer material structure.

3. The liquid crystal device of claim 1, wherein at least two of the plurality of heating lines are different in at least one of a width, a length, and a thickness.

4. The liquid crystal device of claim 1, wherein a width, a length, and a thickness among at least two of the plurality of heating lines is substantially identical.

5. The liquid crystal device of claim 1, wherein a resistance value among at least two of the plurality of heating lines is substantially identical.

6. The liquid crystal device of claim 1, wherein a voltage difference between the first voltage line and the second voltage line of one of the plurality of heating units is different from a voltage difference between the first voltage line and the second voltage line of another of the plurality of heating units.

7. The liquid crystal device of claim 1, wherein a first voltage difference between the first voltage line and the second voltage line of one of the plurality of heating units, and a second voltage difference between the first voltage line and the second voltage line of another of the plurality of heating units, wherein the one of the plurality of heating units is adjacent to the another of the plurality of heating units, and an absolute value of the first voltage difference is identical to an absolute value of the second voltage difference.

8. The liquid crystal device of claim 1, wherein a voltage value of the first voltage line of one of the plurality of heating units is equal to a voltage value of the second voltage line of another of the plurality of heating units, wherein the one of the plurality of heating units is adjacent to the another of the plurality of heating units.

9. The liquid crystal device of claim 1, wherein every two adjacent heating lines are separated by an identical spacing.

10. The liquid crystal device of claim 9, wherein a ratio of the width over a square of the length of each of the plurality of heating lines is substantially identical.

11. The liquid crystal device of claim 1, wherein the pair of substrates are oval.

12. The liquid crystal device of claim 11, wherein at least one of the plurality of heating lines is curvedly disposed on one of the pair of substrates.

13. A liquid crystal device, comprising:
a pair of substrates;
a liquid crystal, disposed between the pair of substrates; and
a plurality of heating units, disposed on one of the pair of substrates, wherein the plurality of heating units are separated from one another;
wherein the plurality of heating units includes a first voltage line, a second voltage line, and a plurality of heating lines, and the heating lines are coupled between the first voltage line and the second voltage line.

14. The liquid crystal device of claim 13, wherein the pair of substrates are rectangular.

15. The liquid crystal device of claim 13, wherein the pair of substrates are semicircular.

16. The liquid crystal device of claim 15, wherein the pair of substrates each comprises a straight edge and an arc edge.

17. The liquid crystal device of claim 16, wherein the first voltage line and the second voltage line are deposited on the straight edge.

18. The liquid crystal device of claim 17, wherein the first voltage line and the second voltage line are separated each other.

19. The liquid crystal device of claim 16, wherein the plurality of heating lines are separated by a substantially identical spacing.

20. The liquid crystal device of claim 16, wherein the plurality of heating lines are extending from the first voltage line to the second voltage line.
